(19) United States
(12) Patent Application Publication
(10) Pub. No.: US 2025/0329763 A1
(43) Pub. Date: Oct. 23, 2025

(54) Fuel Cell Exhaust Separation System and Control Method

(71) Applicant: Infintium Fuel Cell Systems, Inc., Greenville, SC (US)

(72) Inventors: Robert Morris Clippard, Greenville, SC (US); Brian Anthony Robinson, Simpsonville, SC (US)

(21) Appl. No.: 19/178,087

(22) Filed: Apr. 14, 2025

Related U.S. Application Data
(60) Provisional application No. 63/634,397, filed on Apr. 15, 2024.

(51) Int. Cl. H01M 8/04828; G10K 11/16; H01M 8/04119; H01M 8/04746

(52) U.S. Cl. CPC H01M 8/04843; G10K 11/161; H01M 8/04179; H01M 8/04761; H01M 2250/20

(57) ABSTRACT

A system includes an inlet configured to receive an exhaust stream generated from a fuel cell stack, an electronically controlled variable orifice configured to control airflow and pressure of the exhaust stream before the exhaust stream reaches a centrifugal water separator, the centrifugal water separator configured to remove reaction byproduct water from the exhaust stream, and a muffler comprising a plurality of baffles, wherein the plurality of baffles is designed to reduce a noise level of the exhaust stream to a predetermined level.

### CROSS-REFERENCE TO RELATED APPLICATIONS

This patent application claims priority to U.S. Provisional Application No. 63/634,397, filed on Apr. 15, 2024 and entitled “Fuel Cell Exhaust Separation System and Control Method,” which is incorporated herein by reference as if reproduced in its entirety.

### TECHNICAL FIELD

The present invention relates to a fuel cell system, and, in particular embodiments, to a fuel cell exhaust separation system and control method thereof.

### BACKGROUND

Currently, lead-acid batteries are utilized to power for electric forklifts. In contrast to internal combustion engines, forklifts powered by lead-acid batteries operate quietly and offer a cleaner, more environmentally friendly alternative. However, lead-acid batteries are plagued by numerous issues in both production and use. During operation, as the capacity of the lead-acid battery diminishes, the performance of the forklift declines, resulting in reduced speed and inadequate lifting capacity, significantly impacting work efficiency. Moreover, lead-acid batteries require lengthy recharging periods after use. Additionally, the use of lead-acid batteries can lead to the generation of acid mist, a concern in certain logistic centers where the presence of detected lead is prohibited. Furthermore, the production of lead-acid batteries contributes to environmental pollution.

As technologies further advance, fuel cell systems have emerged as efficient and dependable power sources to replace lead-acid batteries in forklift applications. Compared to their lead-acid counterparts, fuel cell systems offer numerous advantages, including higher energy density, extended lifespan, rapid refueling/recharging capabilities, environmentally friendly operation, enhanced efficiency, scalability, and more.

Fuel cell systems are power supply systems designed to generate electricity through a chemical reaction between a fuel and an oxidizing agent. For instance, certain types of fuel cells utilize hydrogen as the fuel and oxygen from the air as the oxidizer, producing only water and heat as byproducts. These systems generate electricity with significantly lower emissions compared to conventional combustion-based technologies, presenting a clean, efficient, and adaptable solution for various power generation needs.

In a forklift fuel cell system, in order to seamlessly replace the existing lead-acid battery without necessitating modifications to the forklift itself, all components must be consolidated within a rectangular chamber. The forklift fuel cell system includes various elements such as a controller, an energy storage device, a dc/dc power converter, a contactor, a fuel cell system, a hydrogen filling valve, a hydrogen bottle, a hydrogen system, etc. To achieve a weight equivalent to that of the lead-acid battery, additional weights must be incorporated.

During the design and development of hydrogen fuel cell systems for industrial forklift applications, it has become clear that precise control over system air pressure is vital across a varied range of operational scenarios. Effective pressure modulation is essential for maintaining balanced pressures between reactant streams, thus ensuring the structural integrity of the membrane within a proton exchange membrane (PEM) fuel cell stack. Additionally, managing the exhaust stream of PEM fuel cells requires a method to separate accumulated byproduct water, which is then expelled during refueling events. Finally, there is a need for a mechanism to mitigate or attenuate noise from the exhaust stream, ensuring it remains at safe and manageable levels for operation in industrial environments. It is desirable to have a simple and efficient solution to address this issue. The present disclosure addresses this need.

### SUMMARY

These and other problems are generally solved or circumvented, and technical advantages are generally achieved, by preferred embodiments of the present disclosure which provide a fuel cell exhaust separation system and control method thereof.

In accordance with an embodiment, a system comprises an inlet configured to receive an exhaust stream generated from a fuel cell stack, an electronically controlled variable orifice configured to control airflow and pressure of the exhaust stream before the exhaust stream reaches a centrifugal water separator, the centrifugal water separator configured to remove reaction byproduct water from the exhaust stream, and a muffler comprising a plurality of baffles, wherein the plurality of baffles is designed to reduce a noise level of the exhaust stream to a predetermined level.

In accordance with another embodiment, a method comprises receiving an exhaust stream generated by a fuel cell stack, accelerating the exhaust stream by controlling airflow and pressure via an electronically controlled variable orifice before the exhaust stream enters a centrifugal water separator, removing reaction byproduct water from the exhaust stream using a centrifugal water separator, and directing the exhaust stream through a muffler comprising a plurality of baffles to reduce a noise level of the exhaust stream to a predetermined level.

Features described in the context of one embodiment may be used in combination with other embodiments. For example, each of the optional features described above in the context of the apparatus may be used in combination with the system. Each of the optional features described above in the context of the method may be used in combination with the system. Each of the optional features described above in the context of the apparatus may be used in combination with the method.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an example fuel cell power supply system in a perspective view in accordance with various embodiments of the present disclosure;

FIG. 2 is a schematic block diagram of the example fuel cell power supply system in FIG. 1 in accordance with various embodiments of the present disclosure;

FIG. 3 is a simplified diagram of an example fuel cell exhaust separation system in accordance with various embodiments of the present disclosure;

FIG. 4 is a simplified diagram of an example centrifugal water separator shown in FIG. 3 in accordance with various embodiments of the present disclosure;

FIG. 5 is a top view of the example centrifugal water separator shown in FIG. 3 in accordance with various embodiments of the present disclosure; and

FIG. 6 illustrates a flow chart of an example method for controlling the fuel cell exhaust separation system shown in FIG. 3 in accordance with various embodiments of the present disclosure.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood within the scope of this disclosure. It is therefore intended that the appended claims encompass any such modifications or embodiments.

In addition, terms “first”, “second”, and so on, are only used to distinguish one feature (e.g., one entity or operation) from another feature (e.g., another entity or operation), and should not be interpreted as indicating or implying a relative importance, an order, or a quantity of indicated features. A feature limited with “first” or “second” may explicitly indicate or implicitly include one or more of the features.

The present disclosure will be described with respect to preferred embodiments in a specific context, namely a fuel cell exhaust separation system for forklift applications. The disclosure may also be applied, however, to a variety of electric vehicles. Hereinafter, various embodiments will be explained in detail with reference to the accompanying drawings.

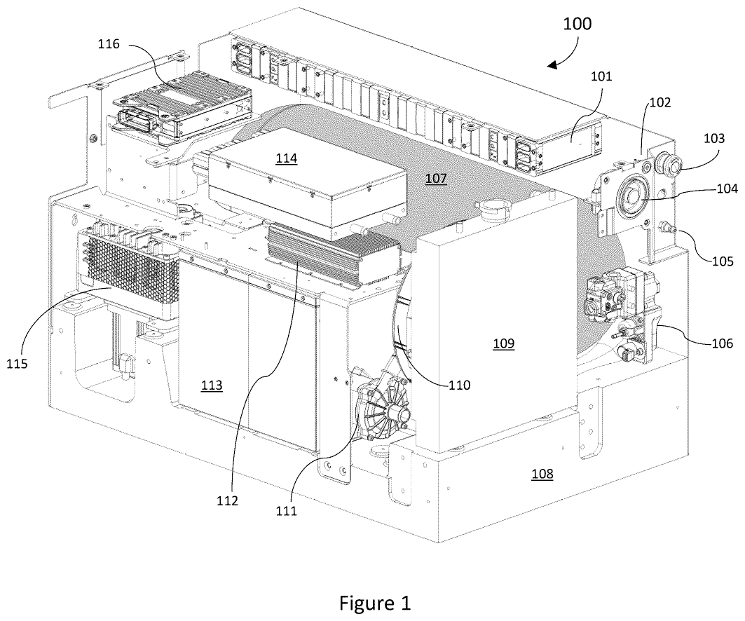

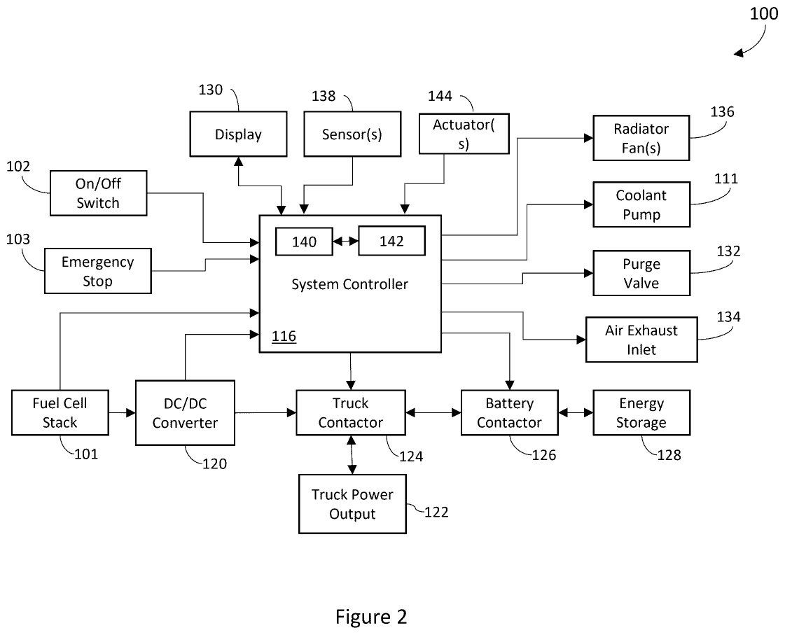

The following description is provided with reference to FIG. 1 and FIG. 2. FIG. 1 is a diagram of an example fuel cell power supply system in a perspective view according to embodiments of the present disclosure. FIG. 2 is a schematic block diagram of the example fuel cell power supply system in FIG. 1, which shows an example implementation of the fuel cell power supply system. In this example, the fuel cell power supply system uses hydrogen as the fuel. However, hydrogen is merely used as an example for illustration purpose. Any other fuel applicable for fuel cell power systems may also be used. The terms of “fuel cell power supply system”, “fuel cell power system”, “fuel cell system” and “system” are used interchangeably in the present disclosure.

The fuel cell system 100 as shown in FIG. 1 may include an fuel cell stack 101, an on/off switch 102, an emergency stop switch 103, a fill port 104, a drain port 105, a pressure regulator 106, a fuel storage tank 107, a system base frame 108, radiator assembly 109, a radiator fan 110, a coolant pump 111, a low power dc/dc converter 112, a battery 113, a high power dc/dc converter 114, an air compressor 115, and a system controller 116. The fuel cell system 100 may further include a truck power output 122, a truck contactor 124, a battery contactor 126, an energy storage device 128, a display 130, a purge valve 132, an air exhaust inlet 134, and actuator(s) 144, which are not shown in FIG. 1.

Components of the fuel cell system 100 in this example are mainly arranged on or above the system base frame 108 in a system housing (not shown). The fuel cell stack 101 may be arranged close to a rear plate of the fuel cell system 100. As an example, the fuel cell stack 101 may be mounted on the rear plate. The rear plate may be part of the system housing. The fuel cell stack 101 may include one or more fuel cells, which may be combined in series into a fuel cell stack (stacked on top of each other) as typically used.

A fuel cell is an electrochemical cell that converts the chemical energy of a fuel (e.g., hydrogen) and an oxidizing agent (e.g., oxygen) into electricity through an electrochemical reaction. As is well known, a fuel cell typically includes an anode, cathode, and an electrolyte membrane. As an example, in a hydrogen fuel cell, hydrogen is passed through the anode and oxygen is passed through the cathode. At the anode, a catalyst splits the hydrogen molecules into electrons and protons. The protons pass through the porous electrolyte membrane, while the electrons pass through an external circuit, generating an electric current. At the cathode, the protons, electrons, and oxygen combine to produce water and heat. A typical fuel cell stack may include hundreds of fuel cells. The amount of power produced by a fuel cell may depend upon various factors, such as the fuel cell type, the fuel cell size, the temperature at which it operates, and the pressure of the gases supplied to the fuel cells, and so on.

The on/off switch 102 is used to turn on or off the fuel cell system 100. The emergency stop switch 103 is configured to stop operation of the fuel cell system 100 immediately in case of emergency, e.g., by cutting off the supply of the fuel.

The fuel (i.e., hydrogen) of the fuel cell system 100 is stored in the fuel tank 107. The fuel tank 107 may be arranged below the fuel cell stack 101. The fuel may be filled into the fuel tank 107 through the fill port 104. Fuel exhaust may be discharged through the drain port 105. The fuel exhaust may primarily include water and non-reactive components, such as traces of unreacted fuel, and possible impurities entering the fuel. The drain port 105 may be closed by the purge valve 132 (not shown in FIG. 1), which will temporarily be opened during purge of the fuel cell stack 101 for discharging the fuel exhaust. Fuel stored in the fuel tank 107 is maintained at a certain pressure level, which may be adjusted through the pressure regulator 106.

The radiator assembly 109 is configured to manage the temperature of the fuel cell system 100 by dissipating excess heat generated during the electrochemical reactions that occur within the fuel cell stack 101. The radiator assembly 109 may include cooling components such as the radiator fan 110 for dissipating heat and the coolant pump 111 for pumping coolant. Hot/warm exhaust air from the fuel cell stack 101 may enter the air exhaust inlet 134 at the radiator assembly 109, be cooled down through the radiator assembly 109, and be re-circulated back to the fuel cell stack 101.

The amount of air available for the electrochemical reaction at the fuel cell stack 101 affects the performance of the fuel cell system 100. Fuel cell performance improves as the pressure of the reactant gases increases. The air compressor 115 is used to push air into the fuel cell stack 101 such that the air is provided to the fuel cell stack 101 at a desired flow rate. As an example, the air compressor 115 may raise the pressure of the incoming air of the fuel cell stack 101 to about 2˜4 times the ambient atmospheric pressure of the fuel cell stack 101.

The fuel cell stack 101 is coupled to a DC/DC converter 120 including the low power DC/DC converter 112 and the high power DC/DC converter 114. Fuel cells produce electricity in the form of direct current (DC). The electric power generated by the fuel cell stack 101 may be converted to different levels of DC power to match various load requirements by the DC/DC converter 120, e.g., to low DC power and high DC power by the low power DC/DC converter 112 and the high power DC/DC converter 114, respectively. The output of the DC/DC converter 120 may be a current or voltage. As an example, the DC/DC converter 120 may be configured to convert a DC voltage output by the fuel cell stack 101 to desired voltage(s). The fuel cell system 100 may include various numbers of DC/DC converters depending on the designs and applications of the fuel cell system 100.

The DC/DC converter 120 may include a communication module, an input voltage measurement module, an input current measurement module, an output voltage measurement module, and/or an output current measurement module. In some embodiments, the DC/DC converter 120 may control, according to the communication data of the communication module, specific numerical values of the output current and voltage, and output, through the communication module, data such as input voltages, input currents, output voltages, output currents, etc. The state data of the DC/DC converter 120 may include DC/DC input currents, and/or DC/DC input voltages.

The DC/DC converter 120 may be connected to the truck power output 122 through the truck contactor 124. The truck contactor 124 may be a normal open type high-current contactor. The fuel cell system 100 supplies the electric energy generated by the fuel cell stack 101 to external devices/apparatus (referred to as external power receivers thereafter) through the truck power output 122.

The DC/DC converter 120 may also be connected to the energy storage device 128 through the truck contactor 124 and the battery contactor 126. The electric energy generated by the fuel cell stack 101 may be stored in the energy storage device 128, e.g., the battery 113. The energy stored in the energy storage device 128 may also be supplied to the external power receivers through the battery contactor 126, the truck contactor 124 and the truck power output 122.

The system controller 116 is configured to manage and control operation of the fuel cell system 100. The system controller 116 may include one or more processors 140, such as microprocessors or microcontrollers, which are appropriately configured to carry out fuel cell system operations. The system controller 116 may further include a computer-readable storage device 142 storing computer-readable instructions, which may be executed by the one or more processors 140 of the system controller 116 for carrying out the fuel cell system operations. The computer-readable storage device 142 may include any non-transitory mechanism for storing information in a form readable by a machine (e.g., a computer, a processor). For example, a computer-readable storage device may include read-only memory (ROM), random-access memory (RAM), magnetic disk storage media, optical storage media, flash-memory devices, solid state storage media, and other storage devices and media.

The system controller 116 may be a controller with an integrated design, which may be a scattered fuel cell controller, a whole vehicle controller, or a battery energy management system. The system controller 116 may include an energy management unit, a fuel cell control unit, an energy storage device monitoring unit, a fuel safety monitoring unit, a system failure monitoring unit and/or a startup control unit.

As shown in FIG. 2, the system controller 116 may be connected to various components of the fuel cell system 100, such as the on/off switch 102, the emergency stop 103, the fuel cell stack 101, the DC/DC converter 120, radiator fan(s) 136 such as the radiator fan 110, the coolant pump 111, the purge valve 132, the air exhaust inlet 134, the truck power output 124 through the truck contactor 124, the energy storage 128 through the battery contactor 126, and actuator(s) 144.

As an example, when the on/off switch 102 is switched off, the system controller 116 may receive a signal indicating the switching off of the on/off switch 102, and control to stop operations of the fuel cell system 100, e.g., cutting off the fuel supply to the fuel cell stack 101, turning off the radiator fan(s) 136, and so on. As another example, the system controller 116 may control supplying power to external power receiver(s) and storing energy in the energy storage device 128. As yet another example, the system controller 116 may control to close and open the purge value 132 to discharge fuel exhaust.

The system controller 116 may be connected to the display 130, through which users/operators may interact with the fuel cell system 100. For example, a user may enter instructions through the display 130 and/or set parameter(s) for operations of the fuel cell system 100. A user may monitor operation status or parameters/information displayed on the display 130. The display 130 may be integrated with the system controller 116.

The system controller 116 may be connected to one or more sensors 138. The sensor(s) 138 may include various devices for detecting/sensing/measuring parameters of the fuel cell system 100, such as thermometer(s), timer(s), gas density sensor(s)/meter(s), moisture meter(s), and so on. The sensor(s) 138 may be positioned at various locations depending on their purposes.

In operation, a fuel cell generates electricity through a chemical reaction between hydrogen and oxygen, producing water vapor as a byproduct. Water management is crucial for maintaining the efficiency and performance of the fuel cell. If water accumulates in the fuel cell, it can flood the electrodes and inhibit the reaction. It may lead to decreased power output and potential damage to the fuel cell. Separating water from the exhaust gases helps to regulate water levels within the fuel cell, thereby preventing flooding and ensuring better performance.

The exhaust stream from a fuel cell comprises water vapor and various impurities and/or contaminants that could degrade performance or damage sensitive components. By separating water from the exhaust gases, any contaminants can be more easily removed or treated before they cause harm to the fuel cell.

In a fuel cell system, unreacted hydrogen from the exhaust gases may be recovered and recycled after water has been separated from the exhaust stream. In particular, separating water from the exhaust facilitates the extraction and purification of hydrogen, which can then be recycled back into the fuel cell system for further use, thereby improving overall efficiency and reducing hydrogen consumption.

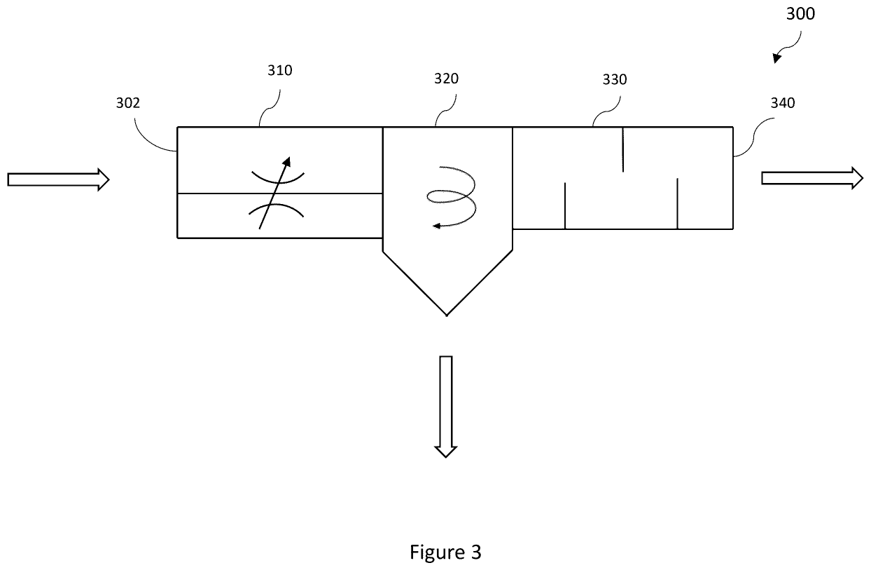

In the present disclosure, water can be separated from the exhaust stream using a fuel cell exhaust separation system shown in FIGS. 3-6. The fuel cell exhaust separation system can be coupled to or integrated with the fuel cell system 100 at an exhaust outlet of the fuel cell stack. For example, the exhaust stream flows from the fuel cell stack 101 into fuel cell exhaust separation system for further processing. The fuel cell exhaust separation system comprises a centrifugal water separator configured to efficiently remove water from the exhaust stream. The treated exhaust gases can be released into the external environment or recirculated back into the fuel cell system 100, depending on system requirements.

FIG. 3 is a simplified diagram of a fuel cell exhaust separation system 300 in accordance with various embodiments of the present disclosure. The fuel cell exhaust separation system 300 comprises an electronically controlled variable orifice 310, a centrifugal water separator 320, a muffler 330. The electronically controlled variable orifice 310, the centrifugal water separator 320, and the muffler 330 are sequentially arranged to regulate and process the exhaust stream.

The electronically controlled variable orifice 310 comprises an exhaust inlet 302, which is configured to receive an exhaust stream generated from a chemical reaction within a fuel cell system. For example, in a hydrogen fuel cell stack, the reaction between hydrogen and oxygen produces an exhaust stream. In other words, the exhaust stream is generated by a hydrogen fuel cell stack. The exhaust stream comprises moisture rich reactant exhaust air comprising a plurality of exhaust gases and the reaction byproduct water.

The electronically controlled variable orifice 310 is used to modulate the system backpressure. In some embodiments, the electronically controlled variable orifice 310 is configured to accelerating the exhaust stream by controlling airflow and pressure of the exhaust stream before the exhaust stream reaches the centrifugal water separator 320.

The centrifugal water separator 320 is configured to remove reaction byproduct water from the exhaust stream. The exhaust stream enters the centrifugal water separator 320 designed to separate exhaust gases from the water. The water is collected at the bottom of the fuel cell exhaust separation system 300 and moved to a holding tank via a pipe. This process takes advantage of the air velocity exiting the reduced size of the orifice to force the water molecules against a wall of the outer structure of the centrifugal water separator 320, thereby separating the water from the gases.

The exhaust gases from the centrifugal water separator 320 are expelled into the muffler 330, which is a section of the device with tuned air channels (e.g., a plurality of baffles) that utilize sound wave cancellation to reduce the noise level of the exhaust gases to appropriate levels for the application. The muffler 330 comprises an exhaust outlet 340, wherein the dried exhaust stream exits from the fuel cell exhaust separation system 300 through the exhaust outlet 340.

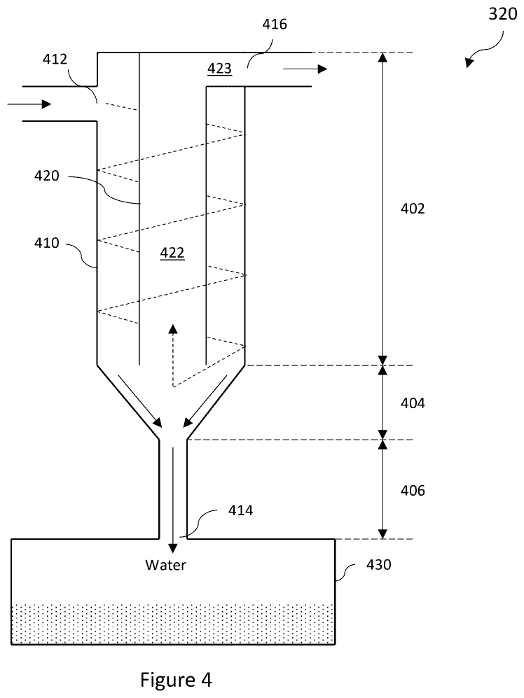

FIG. 4 is a simplified diagram of the centrifugal water separator shown in FIG. 3 in accordance with various embodiments of the present disclosure. The centrifugal water separator 320 comprises an outer structure 410 and an inner structure 420. A main body 422 of the inner structure 420 is surrounded by the outer structure 410.

In some embodiments, the outer structure 410 comprises an upper portion 402, a middle portion 404, and a lower portion 406. Both the upper portion 402 and the lower portion 406 of the outer structure 410 are cylindrical in shape. As shown in FIG. 4, a diameter of the upper portion 402 is greater than a diameter of the lower portion 406. The upper portion 402 functions as a tank where water is separated from the exhaust stream. The middle portion 404 transitions from a large upper opening connected to the upper portion 402 to a smaller lower opening connected to the lower portion 406. The diameter of the upper opening of the middle portion 404 is the same as the upper portion 402, while the diameter of the lower opening of the middle portion 404 is the same as the lower portion 406. In some embodiments, the middle portion 404 is conical in shape. The middle portion 404 functions as a funnel for guiding separated water toward the lower portion 406 for drainage. The lower portion 406 functions as a pipe through which water flows into the water holding apparatus 430 (e.g., a reservoir) through a drain outlet 414. The drain outlet 414 is located at the bottom of the lower portion 406. As shown in FIG. 4, the water holding apparatus 430 is located beneath the lower portion 406, positioned at the base of the centrifugal water separator 320. The reaction byproduct water removed from the exhaust stream is collected and kept in the water holding apparatus 430. The water holding apparatus 430 is periodically drained to maintain continuous operation.

The outer structure 410 has a first opening 412, a second opening 414, and a third opening 416. In some embodiments, the first opening 412 is located on a first side of a shell of the outer structure 410. The second opening 414 is located at a bottom of the centrifugal water separator 320. The third opening 416 is located on a second side of the shell of the outer structure 410. From the first opening 412, the exhaust stream enters into the centrifugal water separator 320. Through the second opening 414, the reaction byproduct water enters into the water holding apparatus 430. A plurality of exhaust gases separated from the exhaust stream enters into the muffler through the third opening 416.

In some embodiments, an uppermost surface of the first opening 412 is aligned with a bottommost surface of the third opening 416, as illustrated in FIG. 4. This arrangement of the first opening 412 and the third opening 416 helps better utilize the inner wall of the outer structure 410 where the water molecules are forced against the inner wall of the outer structure 410, thereby efficiently separating the water from the exhaust stream.

As shown in FIG. 4, the inner structure 420 comprises the main body 422 and a connection pipe 423. The main body 422 is cylindrical in shape. The diameter of the main body 422 of the inner structure 420 is smaller than the diameter of the upper portion 402 of the outer structure. The main body 422 and the connection pipe 423 form an L-shaped structure from cross-sectional view. The connection pipe 423 is connected between the main body 422 and the third opening 416. In some embodiments, a bottommost surface of the main body 422 of the inner structure 420 is aligned with an uppermost point of the middle portion 404 of the outer structure 410, wherein the uppermost point of the middle portion 404 is the same as a bottommost point of the upper portion 402. One advantageous feature of having this arrangement is that the wall of the outer structure 410 can be fully utilized so that the water can be efficiently separated from the exhaust stream.

In operation, the exhaust stream first passes through the electronically controlled variable orifice 310 and then enters the centrifugal water separator 320 through the first opening 412. The exhaust stream then flows in a downward spiral motion between the outer structure 410 and the inner structure 420 of the centrifugal water separator 320, as indicated by the dashed lines in FIG. 4. This spiral motion is induced by the centrifugal water separator 320's design, creating a controlled helical flow that enhances separation efficiency. As the exhaust stream moves downward, centrifugal forces push the heavier water droplets toward the inner wall of the outer structure 410 due to their greater inertia compared to the lighter exhaust gases. As the reaction byproduct water accumulates along the inner wall of the outer structure 410, it coalesces into larger droplets and moves downward due to gravity and centrifugal effects. The separated water is then funneled through the middle portion 404 and directed into the lower portion 406, where it flows through the drain outlet 414 into the water holding apparatus 430 for collection and periodic drainage. Meanwhile, the lighter dry exhaust gases remain concentrated toward the center of the flow path and enter into the inner structure 420 through its opening located in the bottom of the inner structure 420. These lighter dry exhaust gases then flows up through the inner structure 420 and exit toward the muffler via the third opening 416, ensuring that dry exhaust gases are released from the centrifugal water separator 320.

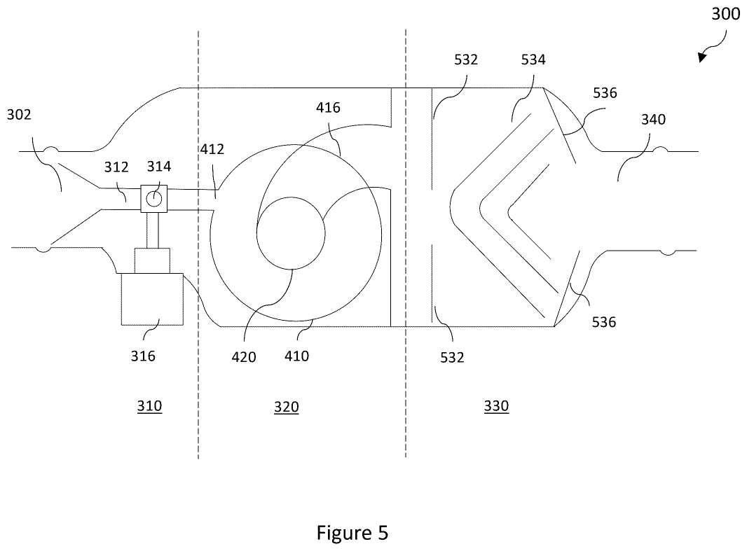

FIG. 5 is a top view of the fuel cell exhaust separation system shown in FIG. 3 in accordance with various embodiments of the present disclosure. From the top view, both the inner structure 420 and the outer structure 410 of the centrifugal water separator 320 are circular in shape and concentric, sharing the same center. The outer structure 410 fully enclosing the inner structure 420.

The electronically controlled variable orifice 310 further comprises a pipe 312 and a control valve 314. In some embodiments, the exhaust inlet 302 may be conical in shape and transitions into the pipe 312. The conical shape of the exhaust inlet 302 reduces the cross-sectional area through which the exhaust stream flows, thereby increasing its velocity as it transitions into the cylindrical pipe 312. In some embodiments, the pipe 312 is cylindrical in shape. The pipe 312 directs the exhaust stream from the exhaust inlet 302 into the control valve 314, enabling the valve to regulate airflow and pressure of the exhaust stream before the exhaust stream reaches the centrifugal water separator 320 through the first opening 412. In some embodiments, the control valve 314 is a conical seat flow valve. In some embodiments, the electronically controlled variable orifice 310 may further comprise a rotary actuator 316. The rotary actuator 316 is operatively connected to the control valve 314. The rotary actuator 316 may be used to manipulate the control valve 314 to adjust an opening size of the electronically controlled variable orifice 310. Reducing the opening size accelerates the exhaust stream by increasing its velocity, thereby enabling precise control of flow and pressure within the fuel cell exhaust separation system 300. This adjustment helps maintain optimal system backpressure based on requirements of flow and pressure for the PEM fuel cell stack. The sizing of the control valve 314 is dependent on the actual application of the system. The rotary actuator 316 may be manually adjusted or automatically controlled by the system controller 116 to dynamically regulate flow.

As shown in FIG. 5, in some embodiments, the first opening 412 of the centrifugal water separator 320 may be located on the left side of the centrifugal water separator 320. The first opening 412 of the centrifugal water separator 320 is connected to the pipe 312. The exhaust stream, after being regulated by the control valve 314, flows into the centrifugal water separator 320 through the first opening 412.

As illustrated in FIG. 5, in some embodiments, the third opening 416 of the centrifugal water separator 320 may be located on the right side of the centrifugal water separator 320, directing the dry exhaust gases toward the muffler 330.

As illustrated in FIG. 5, the muffler 330 is positioned at the rightmost section of the fuel cell exhaust separation system 300 and is designed to reduce the noise level of the dry exhaust gases before they exit. The muffler 330 comprises a plurality of baffles. In some embodiments, the muffler 330 may comprise muffler inlets 532, internal baffles 534, and muffler outlets 536. The muffler inlets 532 may be used to direct exhaust gases from the third opening 416 of the centrifugal water separator 320 into the internal baffles 534. In some embodiments, the muffler inlets 532 may comprise two opposing baffles, located at the left side of the muffler 330, as illustrated in FIG. 5. In some embodiments, the muffler inlets 532 may have angled surfaces to direct exhaust gas into the internal baffles 534. The internal baffles 534 may comprise a plurality of baffles arranged in a structured pattern. The internal baffles 534 are configured to forcing gases to pass through the plurality of baffles, reducing exhaust noise by disrupting sound waves and dissipating energy. The muffler outlets 536 are placed at the right side of the muffler 330 and after the internal baffles 534. The muffler outlets 536 may comprise two opposing baffles, as illustrated in FIG. 5. The muffler outlets 536 are placed near to the exhaust outlet 340. In some embodiments, the muffler outlets 536 may have angled surfaces to direct dry exhaust gases exit the fuel cell exhaust separation system 300 through the exhaust outlet 340.

In operation, exhaust gases enter the muffler 330 through the muffler inlet 532 and pass through the internal baffles 534, which create a controlled flow path that dampens sound waves. As the exhaust gases traverse these baffles, noise is attenuated before the exhaust gases proceed through the muffler outlet 536 and eventually exit via the exhaust outlet 340. The muffler 330 is integrated into the fuel cell exhaust separation system 300 to provide efficient noise reduction while maintaining optimal exhaust flow.

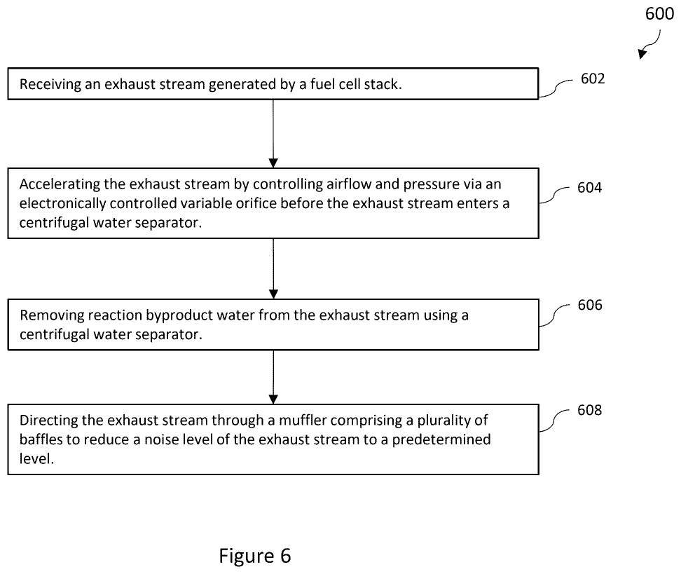

FIG. 6 illustrates a flow chart of an example method 600 for controlling the fuel cell exhaust separation system shown in FIG. 3 in accordance with various embodiments of the present disclosure. This flowchart shown in FIG. 6 is merely an example, which should not unduly limit the scope of the claims. One of ordinary skill in the art would recognize many variations, alternatives, and modifications. For example, various steps illustrated in FIG. 6 may be added, removed, replaced, rearranged and repeated.

At step 602, receiving an exhaust stream generated by a fuel cell stack.

At step 604, accelerating the exhaust stream by controlling airflow and pressure via an electronically controlled variable orifice before the exhaust stream enters a centrifugal water separator.

At step 606, removing reaction byproduct water from the exhaust stream using a centrifugal water separator.

At step 608, directing the exhaust stream through a muffler comprising a plurality of baffles to reduce a noise level of the exhaust stream to a predetermined level.

In some embodiments, the centrifugal water separator comprises an outer structure and an inner structure. The inner structure comprises a main body. The main body of the inner structure is surrounded by the outer structure. An upper portion of the outer structure and a lower portion of the outer structure are both cylindrical in shape. The diameter of the upper portion is greater than the diameter of the lower portion. A middle portion of the outer structure has a large upper opening connected to the upper portion of the outer structure and a small opening connected to the lower portion of the outer structure.

In some embodiments, the centrifugal water separator further comprises a first opening on a first side of the upper portion of the outer structure, a second opening at a bottom of the lower portion of the outer structure, and a third opening on a second side of the upper portion of the outer structure. The exhaust stream enters into the centrifugal water separator through the first opening. The reaction byproduct water enters into a reservoir through the second opening. A plurality of exhaust gases separated from the exhaust stream enters into the muffler through the third opening. A connection pipe of the inner structure is connected between the main body of the inner structure and the third opening. The main body of the inner structure and the connection pipe of the inner structure form an L-shaped structure from a cross-sectional view.

The method further comprises in the centrifugal water separator, configuring the exhaust stream to flow between the outer structure and the inner structure in a downward spiral manner, configuring the reaction byproduct water separated from the exhaust stream to flow into a reservoir connected to the centrifugal water separator, and configuring a plurality of exhaust gases separated from the exhaust stream to flow up through the inner structure and reach the muffler through the third opening.

In some embodiments, an uppermost surface of the first opening is aligned with a bottommost surface of the third opening.

In some embodiments, a bottommost surface of the main body of the inner structure is aligned with an uppermost point of the middle portion of the outer structure.

In some embodiments, the electronically controlled variable orifice comprises a conical seat flow valve and a rotary actuator. The rotary actuator is configured to control the conical seat flow valve to adjust an opening size of the electronically controlled variable orifice dynamically.

The method further comprises separating the reaction byproduct water from gases of the exhaust stream through forcing water molecules against a wall of the outer structure of the centrifugal water separator under a high air velocity of the exhaust stream.

The method further comprises in the muffler, utilizing sound wave cancellation to reduce the noise level of the exhaust stream to the predetermined level.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system comprising:
an inlet configured to receive an exhaust stream generated from a fuel cell stack;
an electronically controlled variable orifice configured to control airflow and pressure of the exhaust stream before the exhaust stream reaches a centrifugal water separator;
the centrifugal water separator configured to remove reaction byproduct water from the exhaust stream; and
a muffler comprising a plurality of baffles, wherein the plurality of baffles is designed to reduce a noise level of the exhaust stream to a predetermined level.

2. The system of claim 1, further comprising:
a reservoir placed underneath the centrifugal water separator, wherein the reaction byproduct water removed from the exhaust stream is collected and kept in the reservoir, and the reservoir is periodically drained.

3. The system of claim 1, wherein:
the centrifugal water separator comprises an outer structure and an inner structure, and wherein:
a main body of the inner structure is surrounded by the outer structure;
the exhaust stream flows between the outer structure and the inner structure in a downward spiral manner;
the reaction byproduct water separated from the exhaust stream flows into a reservoir connected to the centrifugal water separator; and
a plurality of exhaust gases separated from the exhaust stream flows up to reach the muffler through the inner structure.

4. The system of claim 3, wherein the outer structure of the centrifugal water separator comprises an upper portion, a middle portion, and a lower portion, and wherein:
the upper portion and the lower portion are both cylindrical in shape, with the upper portion having a larger diameter than the lower portion; and
the middle portion is connected between the upper portion and the lower portion.

5. The system of claim 3, wherein the centrifugal water separator further comprises:
a first opening on a first side of a shell of the outer structure, and wherein the exhaust stream enters into the centrifugal water separator through the first opening;
a second opening at a bottom of the centrifugal water separator, and wherein the reaction byproduct water enters into the reservoir through the second opening; and
a third opening on a second side of the shell of the outer structure, and wherein a plurality of exhaust gases separated from the exhaust stream enters into the muffler through the third opening.

6. The system of claim 5, wherein the inner structure comprises the main body and a connection pipe, and wherein the connection pipe is connected between the main body of the inner structure and the third opening at the shell of the outer structure.

7. The system of claim 6, wherein the main body of the inner structure and the connection pipe of the inner structure form an L-shaped structure from a cross-sectional view.

8. The system of claim 6, wherein an uppermost surface of the first opening is aligned with a bottommost surface of the third opening.

9. The system of claim 4, wherein a bottommost surface of the main body of the inner structure is aligned with an uppermost point of the middle portion of the outer structure.

10. The system of claim 3, wherein the electronically controlled variable orifice comprises a conical seat flow valve and a rotary actuator, the rotary actuator being configured to control the conical seat flow valve to adjust an opening size of the electronically controlled variable orifice.

11. A method comprising:
receiving an exhaust stream generated by a fuel cell stack;
accelerating the exhaust stream by controlling airflow and pressure via an electronically controlled variable orifice before the exhaust stream enters a centrifugal water separator;
removing reaction byproduct water from the exhaust stream using a centrifugal water separator; and
directing the exhaust stream through a muffler comprising a plurality of baffles to reduce a noise level of the exhaust stream to a predetermined level.

12. The method of claim 11, wherein the centrifugal water separator comprises an outer structure and an inner structure, and wherein:
the inner structure comprises a main body, wherein the main body of the inner structure is surrounded by the outer structure;
an upper portion of the outer structure and a lower portion of the outer structure are both cylindrical in shape, and wherein a diameter of the upper portion is greater than a diameter of the lower portion; and
a middle portion of the outer structure has a large upper opening connected to the upper portion of the outer structure and a small opening connected to the lower portion of the outer structure.

13. The method of claim 12, wherein the centrifugal water separator further comprises:
a first opening on a first side of the upper portion of the outer structure, and wherein the exhaust stream enters into the centrifugal water separator through the first opening;
a second opening at a bottom of the lower portion of the outer structure, and wherein the reaction byproduct water enters into a reservoir through the second opening;
a third opening on a second side of the upper portion of the outer structure, and wherein a plurality of exhaust gases separated from the exhaust stream enters into the muffler through the third opening; and
a connection pipe of the inner structure connected between the main body of the inner structure and the third opening, wherein the main body of the inner structure and the connection pipe of the inner structure form an L-shaped structure from a cross-sectional view.

14. The method of claim 13, further comprising:
in the centrifugal water separator, configuring the exhaust stream to flow between the outer structure and the inner structure in a downward spiral manner;
configuring the reaction byproduct water separated from the exhaust stream to flow into a reservoir connected to the centrifugal water separator; and
configuring a plurality of exhaust gases separated from the exhaust stream to flow up through the inner structure and reach the muffler through the third opening.

15. The method of claim 14, wherein:
an uppermost surface of the first opening is aligned with a bottommost surface of the third opening; and
a bottommost surface of the main body of the inner structure is aligned with an uppermost point of the middle portion of the outer structure.

16. The method of claim 12, wherein:
the electronically controlled variable orifice comprises a conical seat flow valve and a rotary actuator, the rotary actuator being configured to control the conical seat flow valve to adjust an opening size of the electronically controlled variable orifice dynamically.

17. A full cell system, comprising:
a fuel storage tank,
a fuel cell stack configured to receive fuel from the fuel storage tank and generate electrical power;
a pressure regulator configured to control a fuel pressure within the fuel storage tank;
a radiator fan configured to dissipate heat generated during operation of the fuel cell stack;
a coolant pump configured to circulate coolant throughout the fuel cell system;
one or more sensors configured to measure parameters of the full cell system;
a DC/DC converter configured to convert a voltage output by the fuel cell stack to desired voltage;
a system controller configured to monitor and control operation of the full cell system; and
a fuel cell exhaust separation system comprising:
an inlet configured to receive an exhaust stream generated from a fuel cell stack;
an electronically controlled variable orifice configured to control airflow and pressure of the exhaust stream before the exhaust stream reaches a centrifugal water separator;
the centrifugal water separator configured to remove reaction byproduct water from the exhaust stream;
a reservoir placed underneath the centrifugal water separator for collecting the removed reaction byproduct water; and
a muffler comprising a plurality of baffles designed to reduce a noise level of the exhaust stream to a predetermined level, wherein at least a portion of the exhaust stream exiting the fuel cell exhaust separation system is recirculated to the fuel cell stack.

18. The full cell system of claim 17, wherein the centrifugal water separator comprises an outer structure and an inner structure, and wherein:
the inner structure of the centrifugal water separator comprises a main body and a connection pipe, wherein the main body and the connection pipe form an L-shaped structure from a cross-sectional view, the main body of the inner structure being surrounded by the outer structure; and
the outer structure of the centrifugal water separator comprises a cylindrical upper portion and a cylindrical lower portion, the upper portion having a larger diameter than the lower portion.

19. The full cell system of claim 18, wherein the centrifugal water separator further comprises:
a first opening on a first side of the upper portion of the outer structure, and wherein the exhaust stream enters into the centrifugal water separator through the first opening;
a second opening at a bottom of the lower portion of the outer structure, and wherein the reaction byproduct water separated from the exhaust stream enters into the reservoir through the second opening; and
a third opening on a second side of the upper portion of the outer structure, and wherein a plurality of exhaust gases separated from the exhaust stream flow upward through the inner structure and exit the centrifugal water separator through the third opening.

20. The full cell system of claim 18, wherein the electronically controlled variable orifice comprises a control valve and a rotary actuator, the rotary actuator being dynamically controlled by the system controller to adjust an opening size of the electronically controlled variable orifice.
